(19) United States
(12) Patent Application Publication
(10) Pub. No.: US 2007/0297606 A1
(43) Pub. Date: Dec. 27, 2007

(54) Multiple key security and method for electronic devices

(76) Inventors: Thomas E. Tkacik, Phoenix, AZ (US); Lawrence L. Case, Phoenix, AZ (US)

Correspondence Address: INGRASSIA FISHER & LORENZ, P.C. (FS), 7150 E. CAMELBACK ROAD, SUITE 325, SCOTTSDALE, AZ, 85251, US

(21) Appl. No.: 11/476,973

(22) Filed: Jun. 27, 2006

(51) Int. Cl. H04N 7/167

(52) U.S. Cl. 380/239

(57) ABSTRACT

A secure processing system is provided with increased flexibility to secure different categories of data from different entities (e.g., different users or stakeholders) both from external access and from other entities that use the same system. In one embodiment, the secure processing system includes a host processor and a secure memory system which provides for the storage of sensitive data in encrypted form in a storage medium external to the secure processing system. In accordance with the embodiments of the invention, a key generator is provided that uses a base encryption key and a plurality of key modifiers to create a plurality of derivative keys. The derivative keys are used by encryption logic circuitry within the secure memory system for encrypting and decrypting sensitive information. The derivative keys created by the key generator are used to secure different categories of data from different entities.

### FIELD OF THE INVENTION

This invention generally relates to electronic devices, and more specifically relates to data security in electronic devices.

### BACKGROUND OF THE INVENTION

A variety of electronic devices are becoming increasingly important to individuals and businesses. For example, wireless communication devices, computing devices, media players and other devices are becoming more and more indispensable. In these and other devices, data security may be important. Specifically, it may be important to be able to secure data in devices, and to be able to bind data to particular devices.

Securing data in a device may require the ability to store sensitive information within a product and protect this information from disclosure and/or modification. It is generally preferable to store this sensitive information where no external access to this data is possible. Unfortunately, it is difficult to combine technologies to accomplish this. For example, flash memory, EEPROM and fast logic devices are not easily manufactured on the same die due to incompatible process requirements or high cost. This makes it difficult to store sensitive information in non-volatile memory.

Additionally, there is a need to bind data to specific devices. For example, to bind data to a particular device such that the device cannot be made to operate outside authorized parameters. As one example, a typical wireless phone or other communication device will have a code that serves to identify the device to the network. In order to prevent the phone from being switched to a different network without authorization, the code must be protected from disclosure and/or modification.

One limitation with current techniques for protecting data is the inability to effectively distinguish between different types of data from different sources, and to provide effective protection for each of those different types of data. For example, current techniques lack the ability to give different systems and applications different levels of access to different types of data, while maintaining strong protection of data and effectively binding the data to the device. This may limit the flexibility of the device.

Thus, there is a continuing need for improved data security systems with increased flexibility while providing strong data protection.

### BRIEF DESCRIPTION OF DRAWINGS

The preferred exemplary embodiment of the present invention will hereinafter be described in conjunction with the appended drawings, where like designations denote like elements, and:

FIG. 1 is a schematic view host device with a secure processing system in accordance with an embodiment;

FIG. 2 is a schematic view of a secure memory system in accordance with an embodiment;

FIG. 3 is a schematic view of a secure memory system in accordance with a second embodiment;

FIG. 4 is a schematic view of a secure memory system in accordance with a third embodiment; and

FIG. 5 is a schematic view of key modifier registers in accordance with an embodiment.

### DETAILED DESCRIPTION OF THE INVENTION

In one embodiment, secure processing system provides the flexibility to secure different categories of data from different entities (e.g., different users or stakeholders) both from external access and from other entities that use the same system. Additionally, the secure processing system can be implemented to secure data in a wide variety of electronic devices, including communication devices and computing devices.

In one embodiment, the secure processing system includes a host processor and a secure memory system which provides for the storage of sensitive data in encrypted form in a storage medium external to the secure processing system. When instructed by the host processor, encrypted data is retrieved from external storage, decrypted with encryption logic circuitry within the secure memory system and transferred to a secure memory for use by the host processor.

In one embodiment, a key generator is provided that uses a base encryption key to create one or more derivative keys. The derivative keys are used by encryption logic circuitry within the secure memory system for encrypting and decrypting sensitive information. The base encryption key is preferably fixed and functionally unique to each device. A variety of techniques can be used to implement the base encryption key on the secure memory device. For example, it can be laser-scribed on the semiconductor die during fabrication. As another example, it can be implemented by electrically blowing one-time programmable fuses on the semiconductor die.

The derivative keys created by the key generator may be used to secure different categories of data from different entities. For example, to provide hardware, application and/or user specific data security. The multiple derivative keys allow the secure memory system to use different encryption keys to encrypt and decrypt different types of data. This may allow the system to further distinguish between what users and applications should be able to have access to the data. Thus, one device may be able to use many different keys, while still not allowing the data to be copied to another device.

In one embodiment, the key generator uses a plurality of key modifiers to generate the derivative keys from the base encryption key. Specifically, one or more of the key modifiers are selectively combined with the base encryption key to create the derivative keys. The key modifiers are selectively combined with the base encryption key using suitable binary operations, such as exclusive or'ing selected key modifier bits with selected bits of the base encryption key. In one embodiment, the key generator receives the plurality of key modifiers from a variety of different sources on the system. This improves the flexibility of the system, and provides increased control of the different data types protected by different derivative keys. For example, the key modifiers can be received from the host processor, the operating system and application programs on the device. Additionally, the key modifiers can be received from the secure memory system to further control access to the different categories of data. In one embodiment, the key modifiers are stored in registers in the secure memory system and selectively used to create derivative keys as required by the system. In the preferred embodiment, each key modifier is combined with a different subset of bits of the base key. This may allow key modifiers to create non-overlapping sets of derived keys. Furthermore, in this embodiment to create a specified derived key, every key modifier is given the proper value.

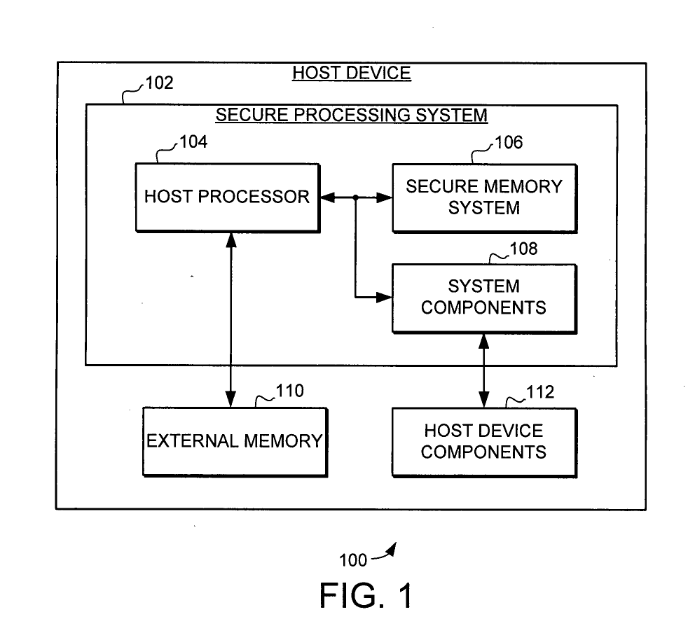

Turning now to FIG. 1, a simplified block diagram of host device that includes a secure memory system in accordance with the preferred embodiments of the present invention. The host device 100 includes a secure processing system 102, having an associated external memory 110, along with other host device components 112. Host device 100 can be any type of device in which a secure memory system can be implemented. For example, the host device 100 can include a communication device such as a cellular or wireless phone, or a wireline communication device such as a computer, or a portion thereof. In these embodiments, the host device components 112 provide for the specific device functionality not described in detail in FIG. 1, such as various components for wireless or wireline communication, including the communication of voice and/or data.

The secure processing system 102 includes a host processor 104, a secure memory system 106, and system components 108. The host processor 104 is coupled to the secure memory system 106 and the external memory 110 through a suitable bus system. In accordance with the preferred embodiment, the host processor 104, secure memory system 106, and system components 108, are all fabricated on a single integrated circuit chip, and is typically separate from the external memory 110 and the other device components 112. Host processor 104 may be one or more processing elements and is preferably the main controller for secure processing system 102. Preferably, host processor 104 is a digital signal processor (DSP) or a micro-controller. The system components 108 comprise other components, such as other system processors, memory and other functional elements that are part of host device 100.

The secure memory system 106 provides a secure mechanism for encrypting, decrypting and storing sensitive data. This can include preventing unauthorized access to sensitive data, and binding data to this secure processing system 102. The secure memory system will use encryption keys and suitable encryption algorithms to encrypt and decrypt data. In order to keep the data secure, data that has been decrypted is only stored within memory in the secure memory system 106. Thus, any sensitive data is encrypted before it is stored outside the secure memory system 106, for example, in external memory 110 or other types of data storage.

Thus, during operation the host processor 104 will cause encrypted data from the external memory 110 to be passed to the secure memory system 106. The secure memory system 106 will decrypt and store the data using the encryption keys. The decrypted data can be used by the host processor 100 and system components 108 within the secure processing system 102 while maintaining data security. As instructed by the host processor 104, the secure memory system 106 will encrypt data and store the encrypted data in the external memory 110.

Additionally, the secure memory system 106 can serve to bind sensitive data to the secure processing system 102. As will be described in greater detail below, the secure memory system 106 uses encryption keys that are derived from a unique secret base key that is physically part of the secure memory system 106. Thus, the encryption keys cannot be extracted from the secure memory system 106, and thus cannot be used by any other secure memory system 106. This prevents encrypted data from being decrypted by any other device, and thus can be used to bind sensitive data to this host device 100.

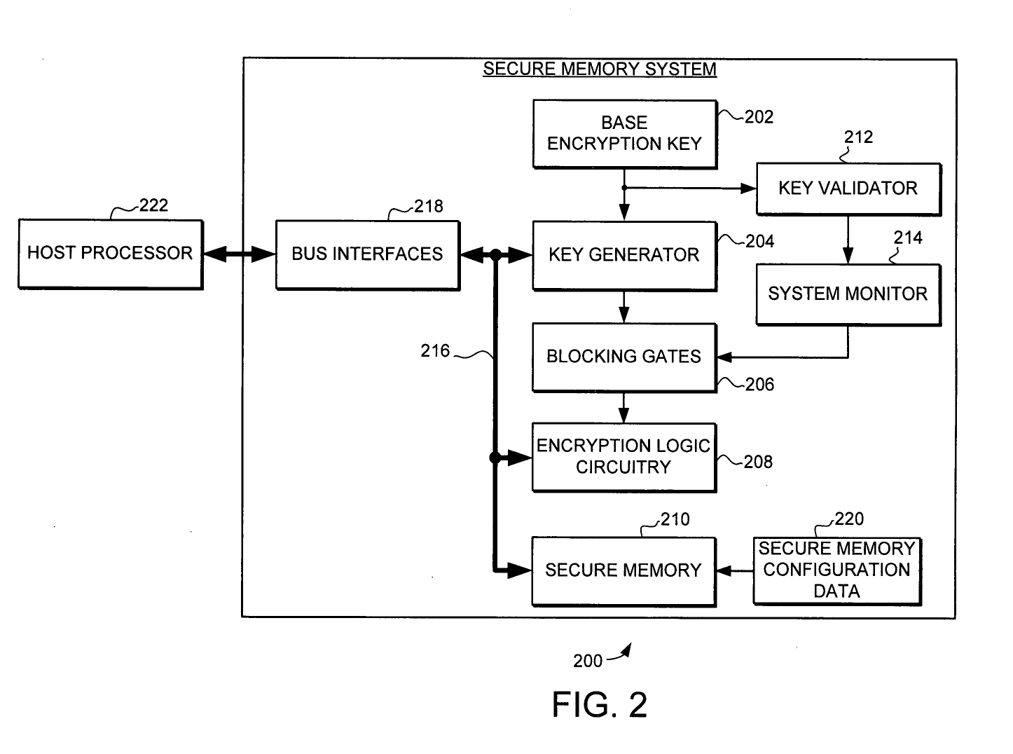

Turning now to FIG. 2, a more detailed embodiment of a secure memory system 200 is illustrated. The secure memory system 200 is an example of the type of memory system that can be used in the secure processing system 102 illustrated in FIG. 1. The secure memory system 200 includes a base encryption key 202, a key generator 204, blocking gates 206, encryption logic circuitry 208, secure memory 210, key validator 212, system monitor 214, a bus 216, bus interfaces 218, and secure memory configuration data 220. As in FIG. 1, the secure memory system 200 is coupled to a host processor 222. In general, the secure memory system 200 provides a mechanism for encrypting, decrypting and storing sensitive data. For encryption and decryption, the secure memory system 200 uses a plurality of keys derived from the base encryption key 202. The use of the plurality of derivative keys provides the flexibility to secure different categories of data for different entities (e.g., different users or stakeholders) both from external access and from other entities that use the same system. Examples of different categories of data for different stakeholders would include; sensitive fabrication data for the silicon manufacturer; feature set configuration data for the OEM product manufacturer; digital rights licensing information for a digital content provider; financial data for a bank or credit institution; and passwords, PIN numbers, credit card numbers or other personal information for the owner of the device.

Specifically, the secure memory system 200 uses the base encryption key 202 to derive the plurality of keys used in the system 200. The base encryption key 202 is preferably fixed and functionally unique to each device. The base encryption key 202 is preferably secure and cannot be read, or otherwise extracted from the device. A variety of techniques can be used to implement the base encryption key 202 on the secure memory device. For example, it can be laser-scribed on the semiconductor die during fabrication. As another example, it can be implemented by electrically blowing one-time programmable fuses on the semiconductor die. In alternative embodiments of the present invention, the base encryption key 202 is implemented using an alternative non-volatile memory such as ROM, EEPROM, MRAM (Magnetoresistive RAM), battery backed RAM or DRAM, or other fast logic elements.

In any embodiment, the base encryption key 202 is a generated sequence of “ones” and “zeros” suitable for an encryption key. The sequence is laser-scribed during fabrication of a semiconductor die, or programmed during initial set up of the device, to create a plurality of fixed “ones” and “zeros” which make up the ones and zeros of the encryption key. It is preferred that the base encryption key 202 be randomly generated and unique for each secure memory system 200 so that the data encrypted by any particular secure memory system 200 can only be decrypted by that particular secure memory. However, in some embodiments it may be possible to a use non-random number as long as its value is functionally unique. As some examples, the base encryption key can be 128 or 256 bits for an Advanced Encryption Standard (AES) encryption algorithm, or 168 bits for a triple Data Encryption Standard (3DES) encryption algorithm, although other key lengths are equally suitable depending on the amount of security desired and the actual encryption algorithm used.

The base encryption key 202 is coupled to the key validator 212 and the key generator 204. In general, the key generator 204 uses the base encryption key 202 to create a plurality of derivative keys, which can then be used by the encryption logic circuitry 208 to encrypt and decrypt different types of data. This allows the secure memory system 200 to further distinguish between what users and applications should be able to have access to the data. Thus, one secure memory system 200 will be able to use many different keys, while not allowing the data to be copied to another device. As will be described in greater detail below, the key generator 204 uses a plurality of key modifiers to generate the derivative keys from the base encryption key 202.

The key validator 212 determines if the base encryption key is valid. In general, to improve the security of the base encryption key 202 it is desirable to prevent direct access to the base encryption key except through the key generator 204. Thus, no other outside system can read the base encryption key 202. This presents a problem in that it makes it difficult to determine if the base encryption key 202 was created correctly and remains uncorrupted. Accordingly, the key validator 212 is implemented to analyze the base encryption key and determine if it is valid.

In one embodiment, the base encryption key 202 is given a hamming code, and the key validator 212 checks that the base encryption key 202 forms a valid code word. The base encryption key 202 is created from a random number to form a hamming code, by attaching extra code bits to the key. In another embodiment, some of the key bits may be used as the code bits. For example, a single parity bit may added to form the base encryption key 202, which can be used to detect all single bit errors which may occur during programming of the base encryption key 202. Alternatively, for a key length of 128 to 256 bits, nine code bits may be added to form the base encryption key 202, which can be used to detect all single, double and triple bit errors which may occur during programming of the base encryption key 202. The use of a code with the base encryption key 202 also allows detection of any bits that may change after programming, due to a hardware fault. The use of the hamming code protects the actual value of the key, while still allowing it to be effectively validated. Thus, the key validator 212 is able to determine if the base encryption key 202 is correct and uncorrupted without exposing the actual value of the key to the outside world.

If and when the base key is validated, that information is passed to the system monitor 214. In general, the system monitor 214 functions to ensure proper operation of secure memory system 200. For example, the system monitor 214 monitors for improper attempts to access encryption keys or the secure memory 210. Preferably, system monitor 214 also monitors the sequence of events at power-up and when a power-up test is not completed successfully, the system monitor 214 prevents access to the secure memory components. In addition, the system monitor 214 monitors activity on other parts of the system, such as on any debug ports.

When the system monitor 214 detects an unauthorized condition, the blocking gates 206 are enabled to disable access to the derivative keys from the key generator 204. In general, the blocking gates 206 serve to prevent the keys from being accessed by the encryption logic circuitry 208 when a potential problem with the keys is determined. In one embodiment, the blocking gates 206 comprise logic “AND” gates which, when activated by a blocking control signal, prevent access to (e.g., block) provided by the key generator 204. In an alternative embodiment, the blocking gates 206 comprise logic “OR” gates.

In addition, the system monitor 214 can prevent access to the encryption logic circuitry 208, and can clear the secure memory 210 to erase any information that has been stored therein.

When the keys are properly validated, and no unauthorized access attempts have been detected, the system monitor 214 opens the blocking gates 206 and allows the derivative keys to pass to the encryption logic circuitry 208.

The encryption logic circuitry 208 provides the mechanisms needed for encrypting and decrypting data using the encryption keys from the key generator 204. The encryption logic circuitry 208 can be implemented using any suitable hardware components. Furthermore, the encryption logic circuitry 208 can be implemented to use any suitable cryptographic techniques. One suitable example is Advanced Encryption Standard (AES). AES is a symmetric encryption algorithm that relies on well respected cryptographic techniques that are particularly immune to attacks based on the existence of multiple related keys. There are cryptanalytic techniques (called related key attacks) which can be used to extract a key when multiple related keys are available to the attacker. The secure memory system 200, with its ability to generate many derivative keys would be a suitable platform on which to launch such an attack, if an improperly chosen encryption algorithm were used. Thus, it is desirable that an encryption algorithm that is resistant to these types of attacks be used, such as AES. Of course, other suitable techniques can be used, including triple Data Encryption Standard (3DES).

When sensitive data is decrypted by the encryption logic circuitry 208 it is stored in the secure memory 210. The secure memory 210 is coupled to encryption logic circuitry 208, the key generator 204 and the host processor 212 through data bus 216 and bus interfaces 218. The secure memory 210 preferably comprises a random access memory (RAM) having zeroizing input. The zeroizing input allows the contents of the secure memory 210 to be erased, for example, by causing the contents to be set to a fixed value such as zero or another predetermined value when a zeroized signal is received. System monitor 214, for example, can send the zeroizing signal to secure memory 210 upon the occurrence of any one of several predetermined conditions. Such conditions may include, for example, a detection of inappropriate access to the secure information in the secure memory 210 or the completion of an operation where the data in the secure memory 210 is no longer needed.

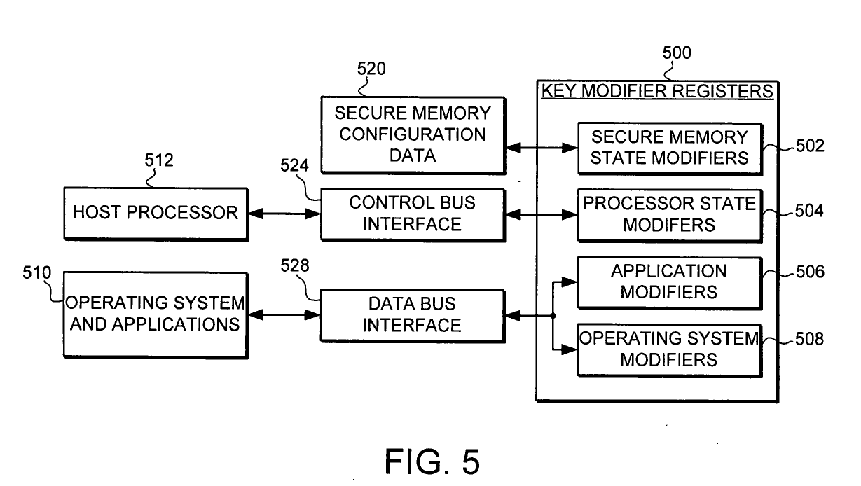

The secure memory configuration data 222 stores configuration data used to control the operation of the secure memory. For example, it stores configuration data related to access permissions for various portions of the memory. Thus, different applications or users can have different types of access to different portions of memory. This can be used to control which users have the ability to access, read or write to a particular portion of the memory. As will be discussed in greater detail with respect to FIG. 5, the secure memory configuration data can also be used to provide certain types of key modifiers used by the key generator 204.

Thus, the secure memory system 200 provides a secure mechanism for encrypting, decrypting and storing sensitive data, and thus can be used to prevent unauthorized access to sensitive data and bind data to this host device. In order to keep the data secure, data that has been decrypted by the encryption logic circuitry 208 is only stored within the secure memory 210, and used only within the secure processing system 102. Likewise, any sensitive data is encrypted by the encryption logic circuitry 208 before it is stored outside the secure processing system, for example, in external memory.

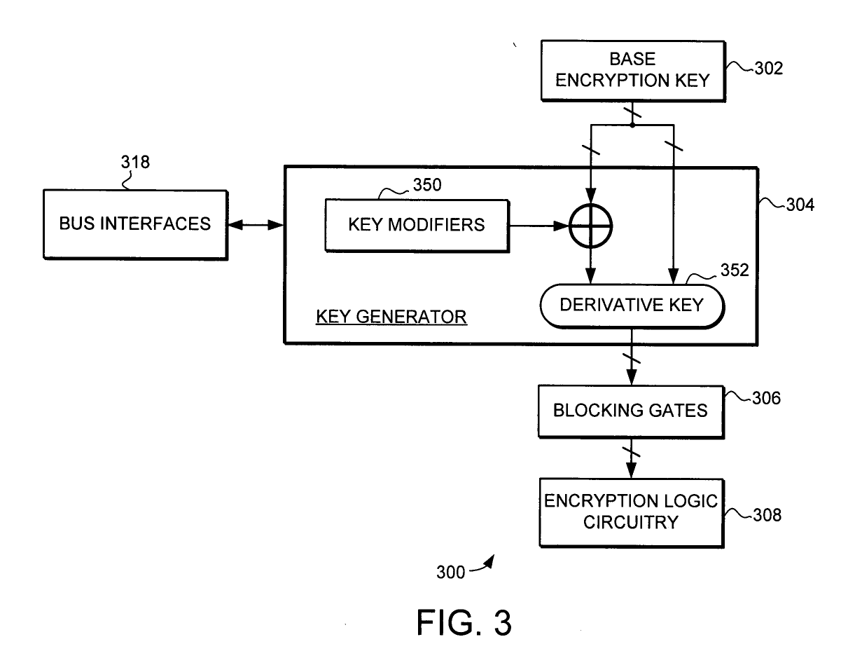

As stated above, the key generator uses key modifiers to generate the derivative keys from the base encryption key, and uses those derivative keys to encrypt and decrypt data. Turning now to FIG. 3, a portion of a second embodiment secure memory system 300 is illustrated. The secure memory system 300 is another example of the type of memory system that can be implemented in a secure processing system, such as secure processing system 102 in FIG. 1. Similar to secure memory system 200 illustrated in FIG. 2, the secure memory system 300 includes a base encryption key 302, a key generator 304, blocking gates 306, encryption logic circuitry 308 and bus interfaces 318. In this illustrated embodiment, the key generator 304 uses key modifiers 350 to generate the derivative keys 352 from the base encryption key 302, and the derivative keys 352 are then used by the encryption logic circuitry 308. Specifically, the secure memory system includes a plurality of key modifiers 350, which can be generated from a variety of sources, and stored in a variety of locations in the secure processing system. During operation of the secure memory system, one or more of the key modifiers from the key modifiers 350 are selectively combined with the base encryption key 302 to create the derivative keys 352. The key modifiers 350 are selectively combined with the base encryption key 302 using an exclusive or'ing binary operation. In this example, the exclusive or'ing is performed between key modifier bits and selected bits of the base encryption key 302. In the preferred embodiment, selected key modifier(s) are combined with a different subset of bits of the base encryption key 302. This allows key modifiers to create non-overlapping sets of derivative keys. With non-overlapping keys, to successfully create and use a particular derivative key every key modifier and the base encryption key 302 must be correct.

Of course, this is just one example of how the key modifiers 350 can be combined with the base encryption key 302. For example, other suitable binary operations can be used, such as two's complement addition. Furthermore, more complex techniques can be used, such as polynomial multiplication in the Galois field GF(2^{m}).

During operation, the secure memory system 300 determines which key modifiers 350 to use, and thus determines what derivative key will be used during encryption and decryption. The selection of the key modifiers 350 can be made based on a variety of factors, such as an operational state of the system. For example one key modifier can be used when the host processor is in a first processing state, and second key modifier can be used with the host processor is in a second processing state. As a second example, the key modifier can be selected based on user entered information. As a third example, the key modifier can be selected based on which application programs are running, or what the current operating system parameters are. In all these cases, the key modifier(s) corresponding to the current state are selected and combined with base encryption key to create a derivative key that will be used for encryption and decryption in that state. When the states change, the key modifiers change, resulting in different encryption keys being used. By selecting and configuring key modifiers from amongst the key modifiers 350, the secure memory system can thus provide the ability to secure different categories of data from different entities with different keys. Additionally, all the derivative keys will be unknown because the base encryption key is secret. This allows the system to further distinguish between what users and applications should be able to have access to the data. Thus, one device will be able to use many different keys, while still not allowing the data to be copied to another device. Thus, the system can provide hardware, application and/or user specific data security.

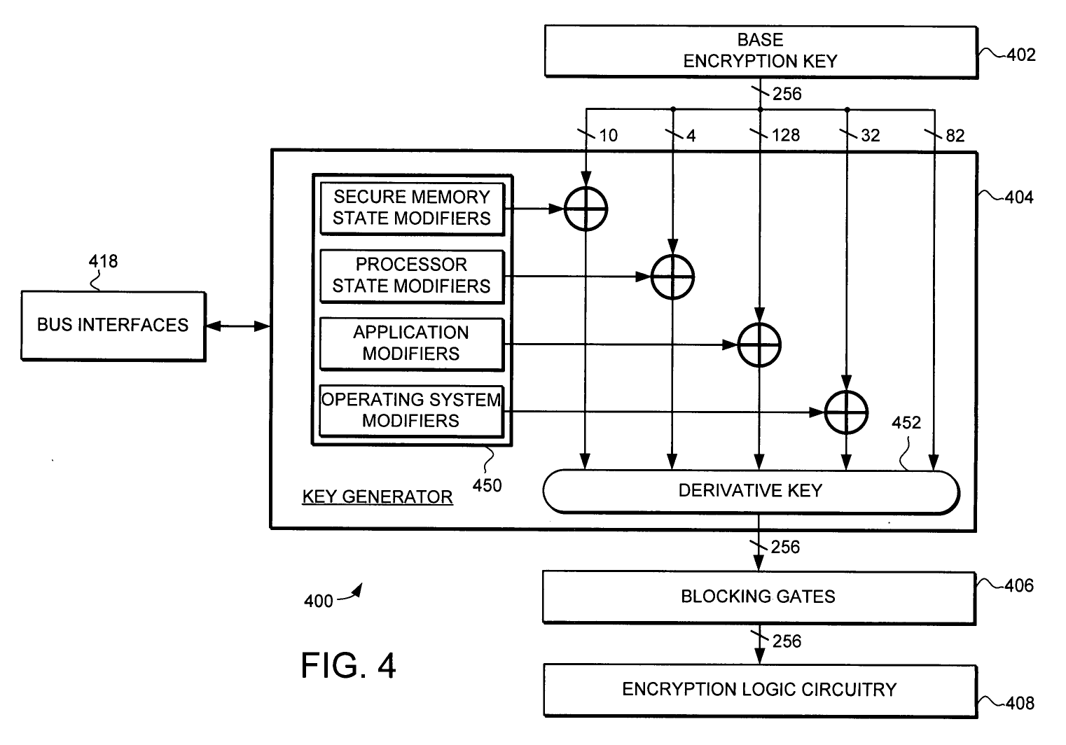

Turning now to FIG. 4, a portion of a third embodiment of the secure memory system 400 is illustrated. The secure memory system 400 is another example of the type of memory system that can be implemented in a secure processing system, such as secure processing system 102 in FIG. 1. Similar to secure memory systems 200 and 300, the secure memory system 400 includes a base encryption key 402, a key generator 404, blocking gates 406, encryption logic circuitry 408 and bus interfaces 418. Again, in this illustrated embodiment, the key generator 404 uses key modifiers 450 to generate the derivative keys 452 from the base encryption key 402. Again, the key modifiers 450 are a plurality of key modifiers, which are generated from a variety of sources, are stored in a variety of locations, and are selectively combined with the base encryption key 402 to create the derivative keys 452. The key modifiers 450 are selectively combined with the base encryption key 402 using a plurality of exclusive or'ing binary operations. In this illustrated example, the exclusive or'ing is performed between four different types of key modifiers and corresponding selected bits of the base encryption key 402. Thus, each of four different types of key modifiers 450 are combined with a different subset of bits of the base encryption key 402. This allows key modifiers 450 to create many different non-overlapping sets of derivative keys.

In the illustrated embodiment four different types of key modifiers 450 are used, i.e., secure memory state modifiers, processor state modifiers, application modifiers, and operating system modifiers. A selected one of each of these different types of modifiers is combined with a different portion of the base encryption key 402 by exclusively or'ing the selected modifier with a corresponding portion of the base encryption key. For example, the secure memory state modifier is exclusively or'ed with the first ten bits, the processor state modifier is exclusively or'ed with the next four bits, and so on. The result is that 174 bits of the 256 bit base encryption key 402 are exclusively or'ed with the key modifiers 450, while 82 bits are directly passed to the derivative key 452.

As stated above, the four different types of key modifiers 450 include secure memory state modifiers, processor state modifiers, application modifiers, and operating system modifiers. These various different types of modifiers allow different functional components of the overall system to specify their own key modifiers, and thus allow the different components of the system to exercise different levels of control over specified portions of secure data.

In the preferred embodiments, the secure memory state modifiers are generated based on the security configurations for various portions of data in the secure memory system. This allows different components and users to have different access permissions to different portions of data, and for these different permissions to be used to generate different keys that correspond to these different permissions. This helps to prevent attacks from malicious software. For example, a program could be executed while keeping the code itself secret. The access permissions would be set to execute only, and the derivative key based on that access permission. Before the code is decrypted, the secure memory is set to execute only. If malicious software were to attempt to read the actual program code, it would need to first decrypt the program. It would have to make the secure memory execute only (no read), and therefore could not read the decrypted program code. If it set the permissions on the secure memory to read, then the derivative key would be generated incorrectly, and the code would not be decrypted properly.

The processor state modifiers preferably identify an operational state of the host processor coupled to the secure memory system. For example, the processor state modifiers can be based on whether or not the host processor is a user mode or a supervisor mode. As other examples, the processor state modifiers can be based on which of a plurality of direct memory access (DMA) controllers, other host processors, can access the secure memory system 400. Thus, the processor state modifiers are determined by the states of the host processor, and facilitate the use of different derivative keys responsive to different operational states of the host processor. For example, a user application could not read data meant for a supervisor program. Again, it could not decrypt properly, as an incorrect derivative key would be generated in user mode, when the correct derivative key required supervisor mode.

The application modifiers are preferably generated by application programs running on the host processor. This allows specific applications to determine derivative keys to be used for particular purposes. For example, the application modifiers can be generated based on data received by the application from a user. For example, based on user entered PIN numbers, biometric information, or other security information. As other examples, the application modifiers can be based on unique data generated by the application, for example, unique security codes for that application program. Thus, the application modifiers allow different derivative keys to be generated responsive to data from the different applications that run on the host processor.

The operating system modifiers preferably identify applications running on a host processor coupled to the secure memory system. This allows the operating system to determine derivative keys based on which applications are running on the host processor. It should be noted that these modifiers are not specified by application programs themselves (as the application modifiers discussed above are), but are instead specified by the operating system responsive to the applications that are running. Thus, the operating system maintains control over these modifiers and their resulting derivative keys.

It should be noted that these are just four examples of the type of key modifiers that can be used to generate derivative keys. By combining these and other various key modifiers, a multitude of derivative keys can be created and used based many different factors in the system. Thus, one derivative key can correspond to a particular memory configuration, operating in a particular host processor mode, based on specific user entered data, and combined with a particular application software configuration. This gives the secure memory system the flexibility to secure different categories of data from different entities (e.g., different users or stakeholders) both from external access and from other components that use the same system.

In one embodiment, the key modifiers are stored in key modifier registers. Turning now to FIG. 5, an embodiment of key modifier registers 500, and the sources of the various key modifiers, are illustrated schematically. The key modifier registers 500 store secure memory state modifiers 502, processor state modifiers 504, application modifiers 506, and operating system modifiers 508. These modifiers are then selectively retrieved by the key generator when needed to create derivative encryption keys.

It should be noted that the key modifier registers 500 can comprise one or more actual registers in different locations in the secure processing system. Furthermore, the various registers and key modifiers can be stored and used for multiple different purposes. For example, the secure memory state modifiers can be stored in an access permission register, and the values also used to determine access permissions to various items in the system.

In the illustrated embodiment, the secure memory state modifiers are received from secure memory configuration data 520. As was described with reference to FIG. 2, the secure memory configuration data 520 is used to control the operation of the secure memory. For example, it stores configuration data related to access permissions for various portions of the memory. As illustrated in FIG. 5, the secure memory configuration data 520 can also be used to provide the secure memory state modifiers 502. This allows the key generator to generate different keys that correspond to the different access permissions on the secure memory. Thus, keys can be generated for different components and users based in part on their different access permissions.

The processor state modifiers 504 are received from the host processor 512 through the control bus interface 524. Likewise, the application modifiers 506 and the operating system modifiers 508 are received from the operating system and applications 510 (running on the host processor) through the data base interface 528.

The various embodiments thus provide, among other things, a secure processing system with increased flexibility to secure different categories of data from different users or stakeholders, both from external access and from other users of the system. The secure processing system includes a secure memory system which provides for the storage of sensitive data in encrypted form in a storage medium external to the secure processing system. When instructed by a host processor, encrypted data is retrieved from external storage, decrypted with encryption logic circuitry within the secure memory system and transferred to a secure memory for use by the host processor. In accordance with some embodiments, a key generator is provided that uses a base encryption key and a plurality of key modifiers to create a plurality of derivative keys, which are the used by encryption logic circuitry within the secure memory system for encrypting and decrypting sensitive information. The derivative keys created by the key generator are used to secure different categories of data from different users. This allows the system to further distinguish between what users should be able to have access to the data. Thus, one device will be able to use many different keys, while still not allowing the data to be copied to another device.

As one example use of the embodiments, the secure memory system is used to secure the user's sensitive information. For example, the user of a portable communication device can enter sensitive information such as a credit card number and other authentication information into the device. This can be done prior to any use of this information and may be performed using the device's keypad and display or it may involve downloading information from a computer, a network or wireless link.

Once the host processor is loaded with this sensitive information, the host processor uses the secure memory system to encrypt the sensitive information using the appropriate derivative key. After encryption, the encrypted sensitive information is stored in a non-secure memory. The encrypted sensitive information does not need to be protected because this information can only be decrypted and used by the secure memory system with the appropriate derivative key that originally encrypted it.

The communication device may also be loaded with a digital certificate or public key used to establish a secure communication session with an internet vendor. Like the uses of credit card information, the digital certificate may be encrypted by the secure memory using the appropriate derivative encryption key and stored in non-secure memory.

In one embodiment, an additional step for loading the communication device is to establish a personal identification number (PIN) for use in accessing control to the device. As with the credit card information, the PIN is loaded into the device, encrypted by the secure memory system using the appropriate derivative key and stored in non-secure memory. In an alternate embodiment, an additional step for loading the communication device is to establish biometric information for use in accessing control to the device. As with the credit card information, the user's biometric information is loaded into the device, encrypted by the secure memory system using the appropriate derivative encryption key and stored in non-secure memory.

In order to complete a transaction the user either enters the PIN, or provided biometric data to the biometric reception circuitry. This step, for example, helps protect the communication device from misuse in the event that the device is lost or stolen. Once the PIN is entered or the biometric data is received, the encrypted PIN or biometric data is retrieved from non-secure memory and decrypted by the secure memory system using the appropriate derivative encryption key. The decrypted PIN or biometric data is compared to the entered PIN or received biometric data and the transaction continues where the information matches.

The communication device then sends the encrypted certificate to the secure memory where it is decrypted using the appropriate derivative encryption key. The host processor uses this certificate to establish a secure session with, for example, an internet vendor. Secure Socket Layer (SSL), for example, is a standard technique used in the internet community to establish such a session.

Once the secure session is established, the host processor sends the encrypted credit card and authentication information to the secure memory where it is decrypted using the appropriate derivative encryption key. After decryption the host processor sends the decrypted sensitive information to a recipient such as an internet vendor through the secure session previously established.

The internet vendor can then download the encrypted data, such as an encrypted song, along with a song decryption key and digital rights object. The song decryption key and digital rights object would then be placed in the secure memory. A media player application running on the host device 100 would choose an application modifier and therefore a derivative key, to encrypt the song decryption key and digital rights object, and store the encrypted data in external memory. Only this same media player, running on this same host device could generate the proper derivative key and therefore decrypt the song decryption key and digital rights object, and be able to play the song.

One of the advantages that may occur is that the sensitive information is never accessible outside of the host processor and the secure memory system after it is originally loaded. In the preferred embodiment of the present invention, the secure memory and the host processor are on the same chip. In this case the sensitive information is never available outside of this chip, thus protecting the information from any external attempt to intercept it.

Another advantage that may occur is that the user action during the purchase session is primarily only the entering of the PIN or providing the biometric information. The other steps for the secure transaction are automatic and occur without the knowledge or direction of the user.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed. Many modifications and variations are possible in light of the above teaching without departing from the spirit of the forthcoming claims.

1. A secure memory system, the secure memory system comprising:
a base encryption key;
a key generator coupled to the base encryption key, the key generator including at least one key modifier, the key generator adapted to selectively combine the at least one key modifier with base encryption key to generate a plurality of derivative keys;
encryption logic circuitry, the encryption logic circuitry adapted to encrypt and decrypt data using the plurality of derivative keys; and
a memory coupled to the encryption logic circuitry, the memory adapted to store data decrypted by the encryption logic circuitry.

2. The secure memory system of claim 1 wherein the key generator is adapted to selectively combine the at least one key modifier by selectively performing a binary operation between the at least one key modifier and a portion of the base encryption key.

3. The secure memory system of claim 1 wherein the at least one key modifier comprises at least one secure memory state modifier, the at least one secure memory state modifier identifying a security configuration for a portion of data in the secure memory system.

4. The secure memory system of claim 1 wherein the at least one key modifier comprises at least one processor state modifier, the at least one processor state modifier identifying an operational state of a host processor coupled to the secure memory system.

5. The secure memory system of claim 1 wherein the at least one key modifier comprises at least one application modifier, the at least one application modifier comprising identifying data from an application running on a host processor coupled to the secure memory system.

6. The secure memory system of claim 1 wherein the at least one key modifier comprises at least one operating system modifier, the at least one operating system identifying an application running on a host processor coupled to the secure memory system.

7. The secure memory system of claim 1 wherein the base encryption key comprises a one-time programmable fuse key.

8. The secure memory system of claim 1 wherein the base encryption key comprises a laser-scribed encryption key.

9. The secure memory system of claim 1 wherein the secure memory comprises a zeriozable memory having a zerizozing input that causes the contents of the memory to be controllably set to a fixed value.

10. A secure processing system for a communication device comprising:
a host processor;
an external memory coupled to the host processor by a data bus;
a secure memory system coupled to the host processor by a data bus, wherein the secure memory system comprises:
a base encryption key;
a key generator coupled to the base encryption key, the key generator including a plurality of key modifiers, the key generator adapted to selectively combine at least one key modifier from the plurality of key modifiers to the base encryption key to generate a plurality of derivative keys;
encryption logic circuitry, the encryption logic circuitry adapted to encrypt and decrypt data using the plurality of derivative keys;
a memory coupled to the encryption logic circuitry, the memory adapted to store data decrypted by the encryption logic circuitry; and
wherein the external memory is adapted to store data encrypted by the encryption logic circuitry.

11. The secure processing system of claim 10 wherein the key generator is adapted to selectively combine the at least one key modifier from the plurality of key modifiers to the base encryption key by selectively performing a binary operation between the at least one key modifier and a portion of the base encryption key.

12. The secure processing system of claim 10 wherein the plurality of key modifiers comprise:
a plurality of secure memory state modifiers, each secure memory state modifier identifying a security configuration for a portion of data in the secure memory system;
a plurality of processor state modifiers, each processor state modifier identifying an operational state of the host processor;
a plurality of operating system modifiers, each operating system modifier identifying an application running on the host processor; and
a plurality of application modifiers, each application modifier comprising identifying user data from the application running on the host processor.

13. The secure processing system of claim 12 wherein the a plurality of secure memory state modifiers, the plurality of processor state modifiers, the plurality of operating system modifiers, and the plurality of application modifiers are stored in registers coupled to the key generator.

14. The secure processing system of claim 12 wherein the a plurality of secure memory state modifiers are received from secure memory configuration data registers, wherein the plurality of processor state modifiers are received from host processor over a control bus, wherein the plurality of operating system modifiers are received from over the data bus, and the plurality of application modifiers are received over the data bus.

15. The secure processing system of claim 10 wherein the base encryption key comprises at least one of a one-time programmable fuse key and a laser scribed encryption key.

16. The secure processing system of claim 10 wherein the key generator is adapted to selectively combine at least one key modifier from the plurality of key modifiers to the base encryption key to generate a plurality of derivative keys using a binary operation.

17. The secure processing system of claim 10 wherein communication device includes a wireless phone.

18. A method for securing data in an electronic system, the method comprising:
providing a base encryption key on the electronic system;
selectively combining at least one key modifier with the base encryption key to generate one of a plurality of derivative keys;
encrypting data with the one of the plurality of derivative keys; and
storing the encrypted data.

19. The method of claim 18 further comprising retrieving the encrypted data, decrypting the encrypted data using the one of the plurality of derivative keys and storing the decrypted data in a memory for use in the electronic system.

20. The method of claim 18 wherein the at least one key modifier comprises:
a plurality of secure memory state modifiers, each secure memory state modifier identifying a security configuration for a portion of data;
a plurality of processor state modifiers, each processor state modifier identifying an operational state of a host processor;
a plurality of operating system modifiers, each operating system modifier identifying an application running on the host processor; and
a plurality of application modifiers, each application modifier comprising identifying user data from the application running on the host processor.
